(19) United States
(12) Patent Application Publication
(10) Pub. No.: US 2022/0149641 A1
(43) Pub. Date: May 12, 2022

(54) MODULAR PORTABLE POWER STATION WITH BATTERY EXPANSION

(71) Applicant: Halo2Cloud LLC, Hartford, CT (US)

(72) Inventors: Mike Silva, Hartford, CT (US); Troy Starkey, Hartford, CT (US); Fan Ding, Hartford, CT (US); Charles Kong, Hartford, CT (US)

(21) Appl. No.: 17/524,656

(22) Filed: Nov. 11, 2021

Related U.S. Application Data
(60) Provisional application No. 63/112,621, filed on Nov. 11, 2020.

(51) Int. Cl. H02J 7/00

(52) U.S. Cl. CPC H02J 7/0045; H02J 7/0014; H02J 7/0029; H02J 7/0013

(57) ABSTRACT

A modular portable power station comprises a portable power charger that can be supplemented with battery expansion modules that can be mechanically and electrically connected, as needed, to increase power output and capacity. The power charger housing is adapted for mechanical connection to a battery expansion module. When the expansion module is mechanically connected to the charger housing, an internal battery of the expansion module is electrically connected to the internal battery of the power charger to provide a boost of additional power and capacity, which can be transferred to electronic devices in need of a charge. The expansion module includes connection means to complement the connection means on the portable power charger. Additionally, the expansion module may include further connection means, simulating the connection means of the portable power charger, so that multiple expansion modules can be connected to the portable charger, in series, at the same time.

### CROSS REFERENCE TO RELATED APPLICATIONS

The present application claims benefit of priority from U.S. Provisional Patent Application No. 63/112,621, filed on Nov. 11, 2020, which is incorporated herein by reference in its entirety.

### TECHNICAL FIELD OF THE INVENTION

The present invention generally relates to portable power charging devices, and more particularly relates to multi-functional, modular portable power station comprising a portable power charger that can be supplemented with battery expansion modules that can be mechanically and electrically connected to the charger to increase power output and capacity.

### BACKGROUND OF THE INVENTION

Consumers may encounter a variety of circumstances requiring a powered device while in a location lacking a wall outlet or similar power source. For example, a portable power charger is especially useful when walking, camping, at the park, at the mall, or at a sporting event, where one may need to use a phone in an emergency. In other situations, such as those involving a vehicle breakdown, a consumer may have other needs, such as the need for jump starting the vehicle battery or the need for a light source. Accordingly, a portable power station that provides power and other functions and is easy to transport without taking up too much space is desirable.

Portable power chargers are currently available on the market having a variety of shapes, sizes and designs. Commonly, such power chargers have a limited battery capacity, and are therefore limited in what can be charged and how much charge can be provided. Typically, such portable battery chargers are designed for simply charging portable electronic devices, such as smart phones, portable music players, and possibly tablets. Few portable battery chargers are available for recharging laptop computers, as they may have insufficient power capacity in their own internal battery. Even fewer portable battery chargers are available for jump-starting car batteries, and those that are available on the market either are too big to transport in one's pocket, purse or bag, or simply cannot provide a sufficient amount of power to adequately jumpstart and recharge a car battery.

Traditional power station solutions sold in the market can only typically offer high power output along with high capacity for longer device runtime or provide limited power output and limited capacity for shorter device runtime. As a result, such chargers or power stations cannot provide a scalable capacity solution.

In view of the foregoing, there is a need for a portable power charger that can be used to charge a car battery, laptop computers and variety of portable electronic devices, including but not limited to smart phones, mobile phones, data tablets, music players, cameras, camcorders, gaming units, e-books, Bluetooth® headsets and earpieces, GPS devices, and the like, either individually or simultaneously in various combinations, while still being easily portable itself. Accordingly, there is a need for such a charger that has high charge capacity while still being portable, of a compact size, and easy to use in various conditions and locations to charge a car battery, charge a computer, and charge one or more electronic devices simultaneously, including but not limited to in a house or office, a car or an airplane, as well as on-the-go, without compromising operation, performance or appearance. Still further, there is a need for a portable charger that can be easily recharged from an external power source, providing increase flexibility and convenience of use for the portable charger. Accordingly, it is a general object of the present invention to provide a portable charger that improves upon conventional power chargers currently on the market, especially car battery chargers, and that overcomes the problems and drawbacks associated with such prior art chargers.

### SUMMARY OF THE INVENTION

The present invention generally relates to portable power stations, and more particularly relates to a multi-functional, modular portable power station comprising a portable power charger that can be supplemented with battery expansion modules that can be mechanically and electrically connected to the charger, as needed, to increase power output and capacity. As a result, the portable power station can be used for a variety of purposes, requiring high capacity and long run-time, or lower capacity and shorter runtime, including for charging car batteries, portable electronic devices, and laptop computers when a standard external power source is not convenient.

In accordance with an aspect of the present invention, the portable safety device comprises a lightweight portable charger that is provided for charging various devices, including jump starting a car battery, charging laptop computers and a variety of electronic devices, including but not limited to smart phones, mobile phones, data tablets, music players, cameras, camcorders, gaming units, e-books, Bluetooth® headsets and earpieces, GPS devices, and the like, either individually or simultaneously in various combinations. In general, such a portable power charger includes an internal rechargeable battery unit for connecting to and recharging one or more device in need of a power boost, as necessary, and at least one power connection port for connecting the charger unit with at least one such device, or an external power source, or both.

Still further, the portable power charger is designed to connect to one or more battery expansion modules to increase battery capacity as needed. The charger housing includes connection means for easy mechanical connection of an expansion module to the charger. Each expansion module includes an internal rechargeable battery unit. Thus, when the expansion module is mechanically connected to the charger housing, the internal battery unit of the expansion module is electrically connected to the internal battery unit of the power charger to provide a boost of additional power and capacity, which can be transferred to electronic devices in need of a charge. The expansion module includes first connection means to complement the connection means on the portable power charger. Additionally, the expansion module may include a second connection means, simulating the connection means of the portable power charger, so that multiple expansion modules can be connected to the portable charger, in series, at the same time.

Additionally, the portable power charger may include one or more power connection ports that can act as power inputs, power outputs, or both, so as to be used for recharging the internal battery from an external power source connected to the charger via a connection port, or charge electronic devices connected to the charger via a connection port. The portable power charger may further be connected to an external power source and one or more electronic device at the same time, even using the same power connection port, without affecting operation of the charger to receive a charge from the external power source or supply a charge to the electronic devices.

In preferred embodiments of the present invention, the portable power charger is provided with a USB connection port, a DC connection port, and an ignition connection port. The USB connection port can act as a power output and is used for connecting the power charger with electronic devices and/or external power sources using appropriate charging cables and adapter units, as needed. In certain embodiments, multiple USB ports may be provided. Additionally, though shown and described as USB ports, the ports may use other known connection interfaces, such as micro-USB, mini-USB, Apple Lightning™, Apple 30-pin, or the like, without departing from the spirit and principles of the present invention.

The DC connection port can act as a power input and is used for connecting the portable power charger with external power sources using appropriate charging cables with AC/DC adapters, as needed. In an embodiment of the present invention, a separate DC input and DC output may be provided.

The ignition connection port is provided to connect the portable power charger to a car battery for jump starting using jumper cables with positive and negative alligator clips inserted into the port. In preferred embodiments, specially designed end cap is provided on the end of the jumper cables to mate with the socket of the ignition port.

Portable power chargers in accordance with the designs described and illustrated herein are readily portable as a result of the small, compact size of the charger housing. Despite the small size of the portable power charger, the power capacity is very high so that the battery unit can accommodate a variety of devices in need of recharging, including multiple devices at the same time, if necessary. However, as noted, as additional capacity is needed, one or more battery expansion modules can be added to the portable power charger. Such scalable power capacity allows the portable charger to be used to charge a variety of portable electronic devices requiring varying capacity levels and charge lengths. Moreover, such a power capacity level makes the present invention especially suitable for jump-starting a car battery.

The portable power station of the present invention is differentiated from other portable power stations on the market by leveraging the proprietary battery expansion module designs and configurations to provide high output power in a small footprint at a lower cost. This is achieved by leveraging a high-discharge rate battery unit in the portable power charger combined with lower discharge rate batteries in the expansion modules, which allows the portable power stations to be charged as faster charge speeds compared to other power stations in the market. A unique battery balancing control circuit is provided to allow seamless connection and addition of one or more expansion modules to allow for automatic adjustment of run-time capacity.

Furthermore, traditional power station solutions sold in the market can only offer high power output with high capacity for longer device runtime or limited power output and limited capacity for shorter runtime. By comparison, the modular portable power station in accordance with the present invention can provide high power output while providing a scalable capacity solution. This allows the device to be used for common power applications that may require a high surge power but that does not require especially long runtimes. Additionally, the modular power station in accordance with the present invention provides the flexibility to scale the renewable energy, and associated costs, as needed

In embodiments of the present invention, the portable power charger also includes an emergency floodlight and other emergency lighting features, controlled by a power switch on the charger housing.

The portable power charger also includes a power indicator that will indicate the remaining operating status of the charger, as well as other details, such as capacity of the internal rechargeable battery unit in the portable power charger. For example, in preferred embodiments of the present invention, an LCD display screen is provided, which can provide numerous operational details for the portable power station.

The portable power charger also comprises a controller or microprocessor, including a processing unit, configured to execute instructions and to carry out operations associated with the power charger. For example, the processing unit can keep track of the capacity level of the battery unit, store data or provide a conduit means by which data can be exchanged between electronic devices, such as between a smart phone and a computer. The processing unit communicates with the battery unit to determine how much capacity is remaining in the battery. Upon determining the capacity level, the processing unit can communicate with the power indicator means to provide the user with information for how much capacity is remaining in the internal rechargeable battery unit and whether the charger needs to be connected to an external power source for recharging.

In certain embodiments of the portable power charger in accordance with the present invention, connector cables operatively communicating with the internal battery unit can be provided with the charger housing, and in some embodiments, storable within cavities formed in the charger housing from which they can be removed to connect to electronic devices in need of a recharge. Still further, such charging cables can be removable and replaceable so that varying connector interfaces—e.g., USB, Micro-USB, mini-USB, Apple Lightning, or Apple 30-pin—can be used with the portable power charger.

In certain embodiments of the portable power charger, a wireless transmitter and/or receiver can be included in the charger housing for wirelessly recharging the internal batteries of portable electronic devices that have an appropriate wireless receiver or wirelessly recharging the internal battery of the power charger from a wireless recharging station, such as designs shown and described in co-pending U.S. patent application Ser. No. 14/220,524, filed Mar. 20, 2014, and incorporated herein by reference.

Certain exemplary embodiments of the invention, as briefly described above, are illustrated by the following figures.

### BRIEF DESCRIPTION OF THE DRAWINGS

FIG. 1 shows a front, top perspective view of a modular portable power station in accordance with embodiments of the present invention, illustrating a portable power charger attached to a battery expansion module.

FIG. 2 shows a rear, bottom perspective view of the modular portable power station of FIG. 1.

FIG. 3 shows an exploded view of the modular portable power station of FIG. 1.

FIG. 4 shows a front planar view of the modular portable power station of FIG. 1.

FIG. 5 shows a rear planar view of the modular portable power station of FIG. 1.

FIG. 6 shows a left-hand side planar view of the modular portable power station of FIG. 1.

FIG. 7 shows a right-hand side planar view of the modular portable power station of FIG. 1.

FIG. 8 shows a front, top perspective view of an alternate embodiment of a modular portable power station in accordance with the present invention, illustrating a portable power charger attached to two battery expansion modules.

FIG. 9 shows a rear, bottom perspective view of the modular portable power station of FIG. 8.

FIG. 10 shows a first front, top perspective view of a portable power charger for use in the portable power station of FIG. 1.

FIG. 11 shows a second front, top perspective view of the portable power charger of FIG. 10.

FIG. 12 shows a first rear, bottom perspective view of the portable power charger of FIG. 10.

FIG. 13 shows a second rear, bottom perspective view of the portable power charger of FIG. 10.

FIG. 14 shows a front planar view of the portable power charger of FIG. 10.

FIG. 15 shows a rear planar view of the portable power charger of FIG. 10.

FIG. 16 shows a left-hand side planar view of the portable power charger of FIG. 10.

FIG. 17 shows a right-hand side planar view of the portable power charger of FIG. 10.

FIG. 18 shows a top planar view of the portable power charger of FIG. 10.

FIG. 19 shows a bottom planar view of the portable power charger of FIG. 10.

FIG. 20 shows a first front, top perspective view of a battery expansion module for use in the portable power station of FIG. 1.

FIG. 21 shows a second front, top perspective view of the battery expansion module of FIG. 20.

FIG. 22 shows a first rear, bottom perspective view of the battery expansion module of FIG. 20.

FIG. 23 shows a second rear, bottom perspective view of the battery expansion module of FIG. 20.

FIG. 24 shows a front planar view of the battery expansion module of FIG. 20.

FIG. 25 shows a rear planar view of the battery expansion module of FIG. 20.

FIG. 26 shows a left-hand side planar view of the battery expansion module of FIG. 20.

FIG. 27 shows a right-hand side planar view of the battery expansion module of FIG. 20.

FIG. 28 shows a top planar view of the battery expansion module of FIG. 20.

FIG. 29 shows a bottom planar view of the battery expansion module of FIG. 20.

FIG. 30 schematically illustrates connection of a portable power charger as depicted in FIG. 10 to a battery expansion module, as depicted in FIG. 20.

FIG. 31 shows a flowchart of balancing between the battery units of connected components of a modular portable power station in accordance with the present invention.

FIG. 32 shows a front, top perspective view of another alternate embodiment of a modular portable power station in accordance with the present invention, illustrating a portable power charger attached to two battery expansion modules, where each battery expansion module is provided with different functionalities.

### DETAILED DESCRIPTION OF PREFERRED EMBODIMENTS

In embodiments of the present invention, a portable power station may be used to provide power for a variety of devices such as a car battery, laptop computers and portable electronic devices, including but not limited to smart phones, mobile phones, data tablets, music players, cameras, camcorders, gaming units, e-books, Bluetooth® headsets and earpieces, GPS devices, and the like, either individually or simultaneously in various combinations, while still being easily portable itself. The portable power station may also include additional features for emergency situations, including one or more light sources, such as a floodlight, task lighting and emergency signaling, and, in alternate embodiments not illustrated herein, an air compressor for inflating vehicle tires or other inflatables.

Portable safety devices in accordance with the designs described and illustrated herein are readily portable due to the small, compact size of the charger housing. The power capacity is very high so that an internal battery unit can accommodate the various uses described below. For example, in embodiments, an internal battery unit of the portable safety device may be a rechargeable LiPo (lithium polymer) battery operating at a voltage of 11.1 V with charge capacity of approximately 5300 mAh. As noted herein, the present invention is directed to a modular design, whereby additional battery expansion modules can be connected to a portable power charger to increase battery capacity and output levels, and furthermore providing scalable control to the operational capacity and runtime of the power charger.

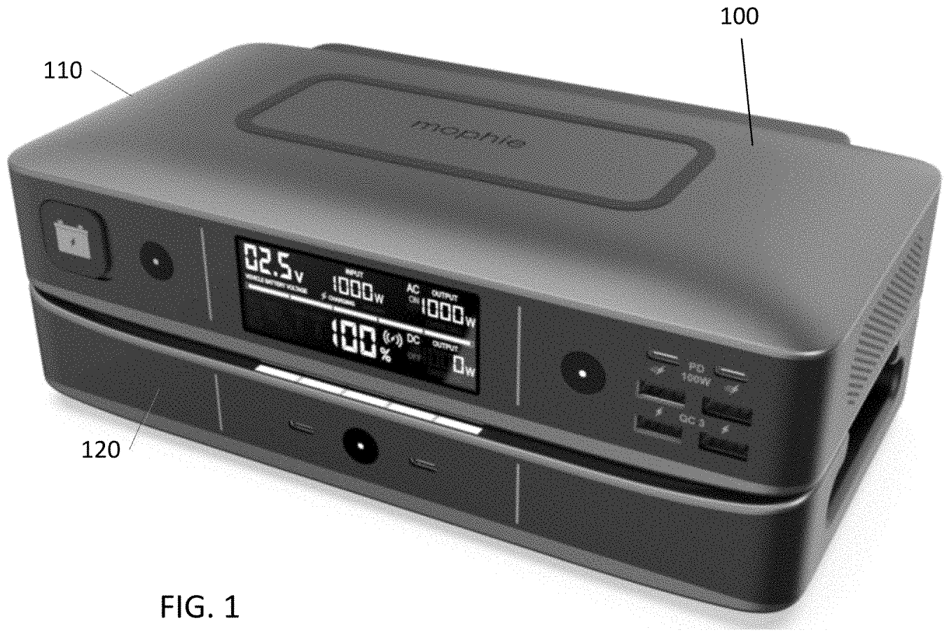

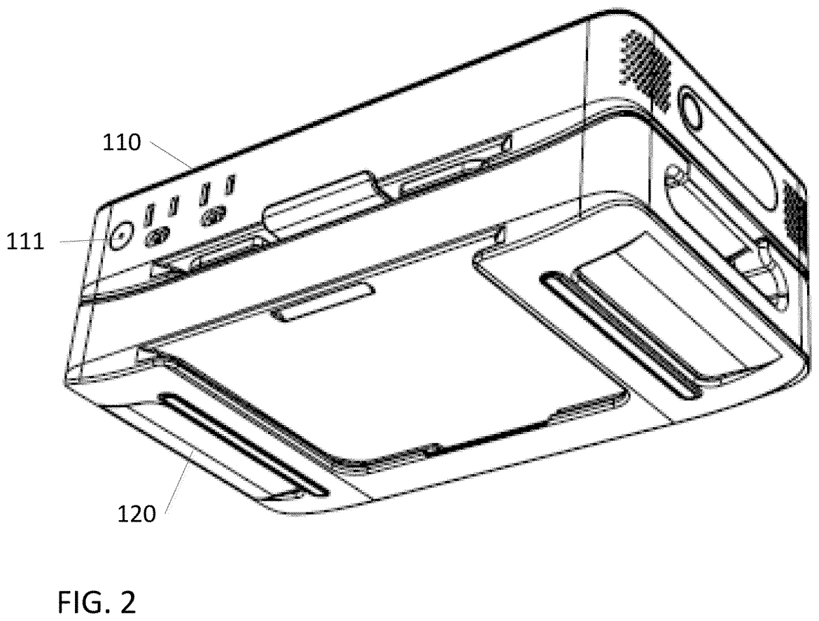

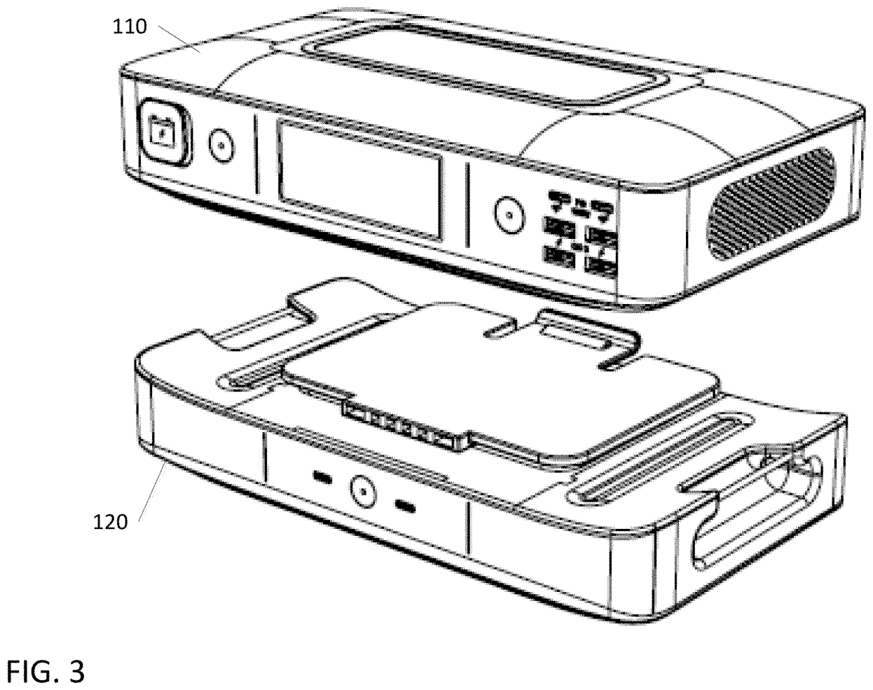

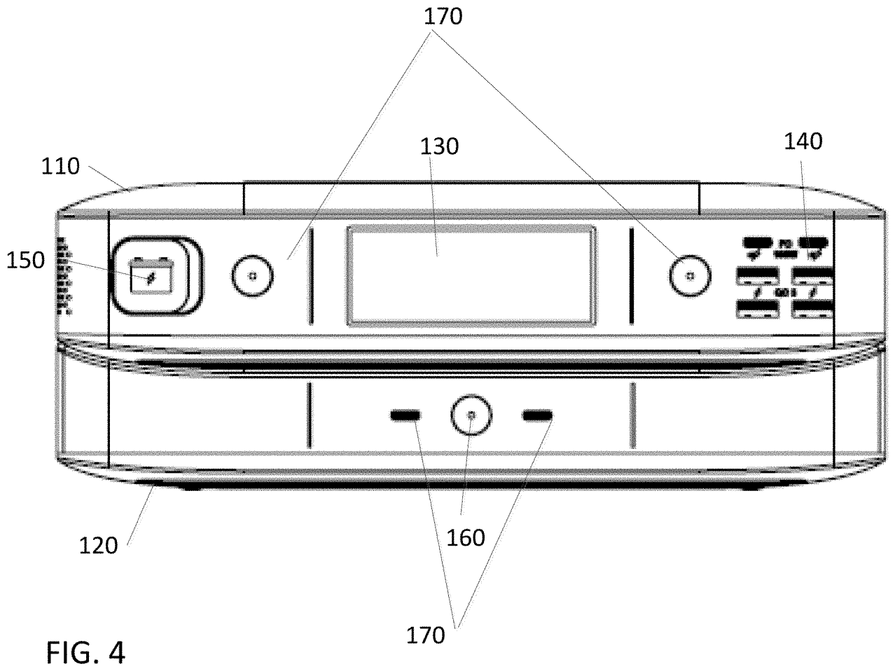

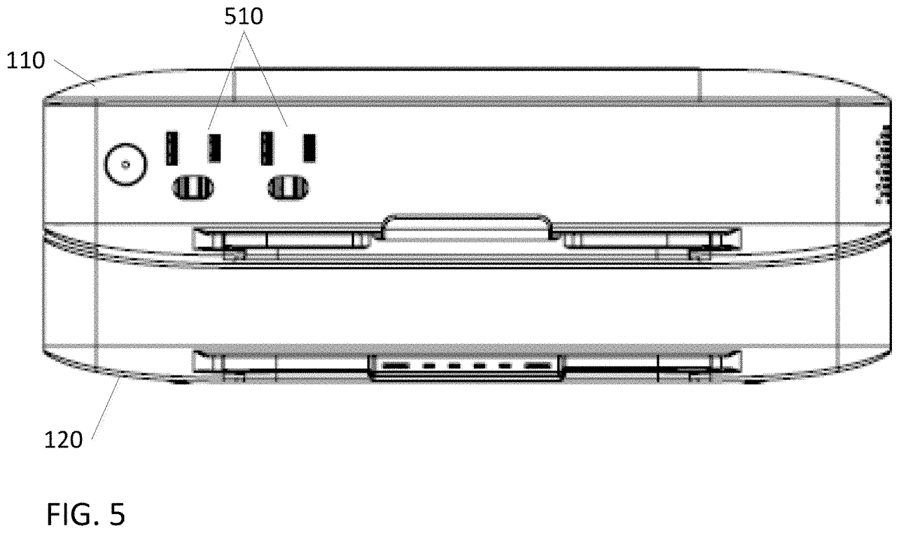

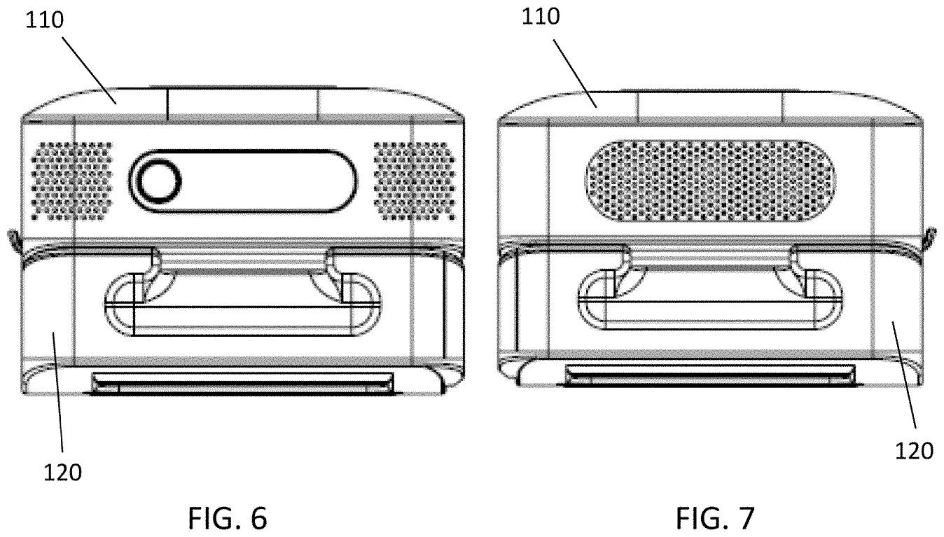

FIG. 1 shows a front, top perspective view of the modular portable power station in accordance with preferred embodiments of the present invention, with a portable power charger 110 connected to one battery expansion module 120. FIG. 2 shows a rear, bottom perspective view of the portable power charger 110 connected to an expansion module 120. FIG. 3 shows an exploded view of the modular portable power station, illustrating the complementary engagement of a portable power charger 110 with a battery expansion module 120. FIG. 4 shows a front planar view of the portable power charger 110, which includes an LCD display 130, a series of connectors including USB connectors 140 showing 4 USB type A connectors and 2 USB type C, a jump start power output connector 150, and a set of operating buttons 170. The battery expansion unit 120 also has USB connectors on its front face 170 and an operating button 160. The USB connectors may be used to charge a unit as well as connect to a power source to charge the expansion module battery 120. FIG. 5 shows a rear planar view of the modular power station with two AC connectors 510. Each AC connector may source power or receive power to charge the internal batteries. FIGS. 6 and 7 show left and right planar views of the modular power station, respectively.

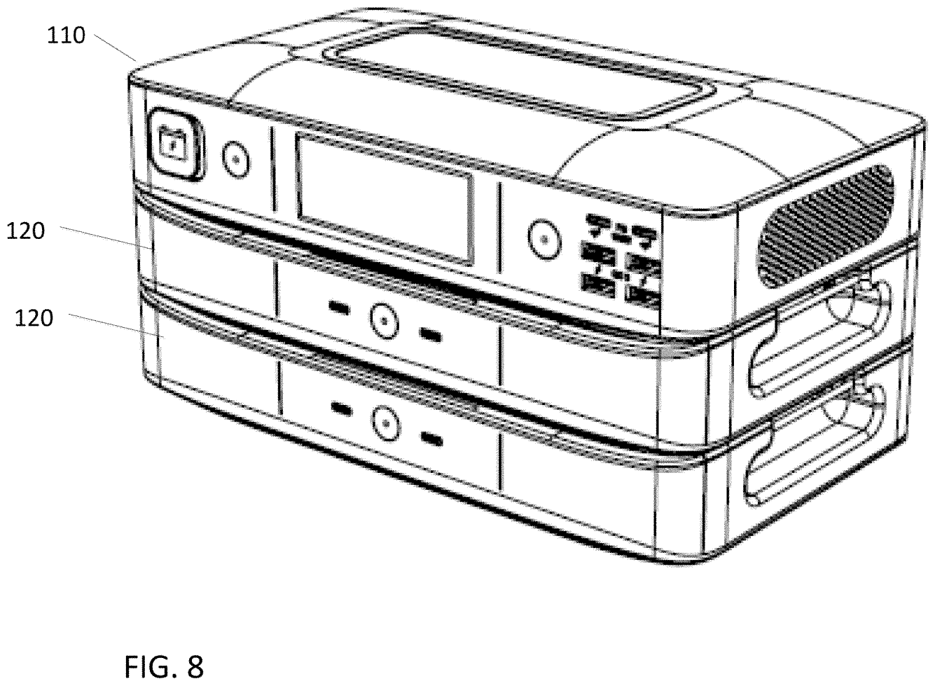

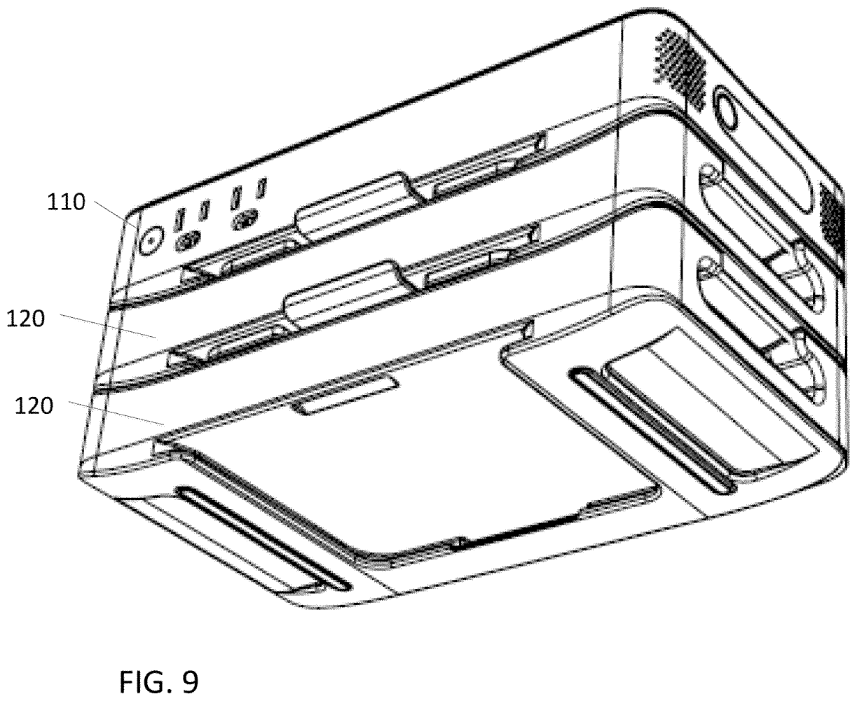

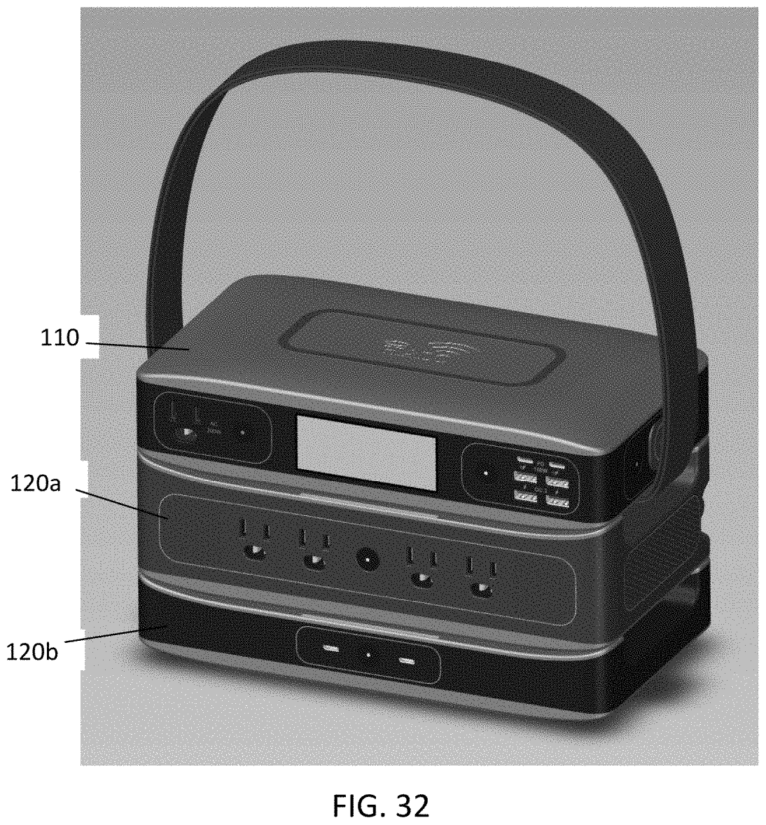

In accordance with the present invention, additional battery expansion modules 120, having like design to the module illustrated in FIGS. 1-7, or varying designs with different functionalities, can be connected, preferably in series, as part of the portable power station, to increase power capacity and output, such as illustrated in FIGS. 8-9 and 32, which show perspective views of the modular power station as so modified. As illustrated, the portable power charger 110 is connected to an expansion module 120 which is connected to another expansion module 120. Although the embodiment in FIGS. 8-9 illustrates identical battery expansion modules, the portable power charger may be connected to battery expansion modules of varying power and run time capacity, and with varying functionalities, without departing from the principles and spirit of the present invention, such as illustrated in FIG. 32.

The portable power station in accordance with the present invention is ideal for home backup power, outdoor use, and anywhere else that portable power may be needed. As illustrated, the power station comprises a modular design that allows scalable power capacity growth on demand from 100 to 1000 watt-hours without sacrificing AC output power form the power station. In effect, the power station provides a renewable energy solution with over 1000 watts of clean power with pure sine wave AC outlets. Inverter technology produces power that is as reliable as standard power outlets.

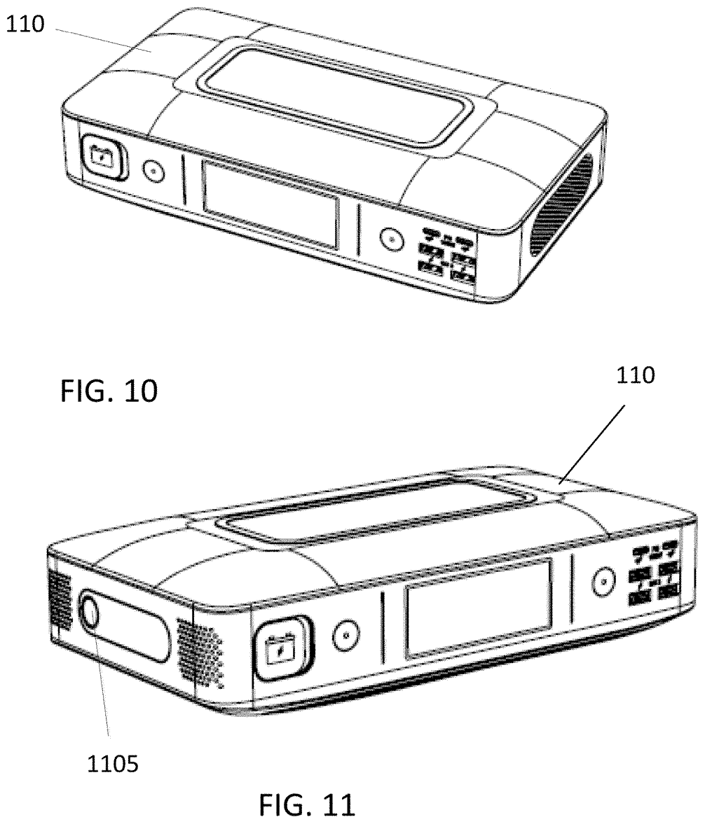

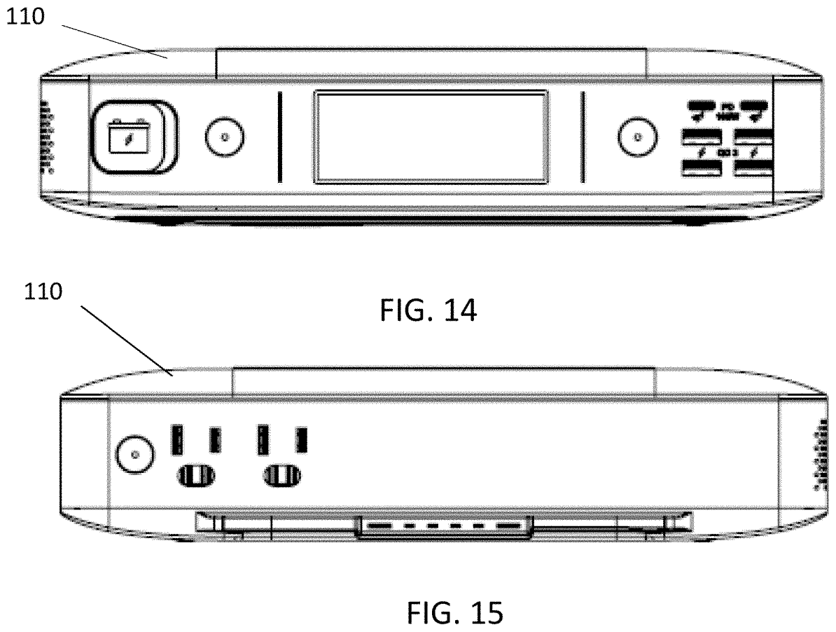

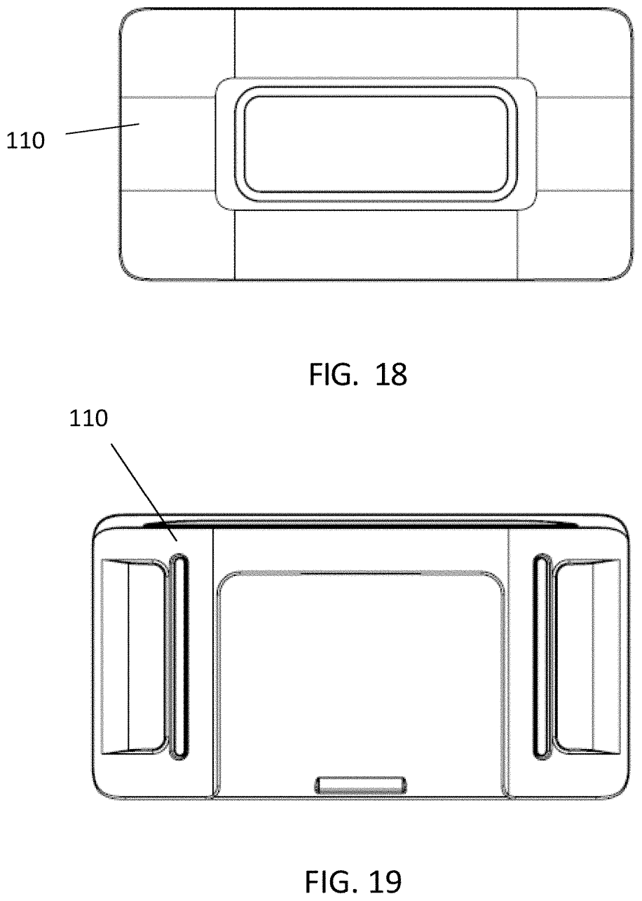

FIGS. 10-19 illustrates a portable power charger 110 that forms a critical part of the portable power station. The portable power charger 110 includes a charger housing that is generally rectangular, with upper and lower faces, front and back faces and two side faces. Although a shape and design of the charger housing is shown and described, other shapes are contemplated without departing from the spirit and principles of the present invention. Further, terms such as “upper,” “lower,” “front” and “back” are used for ease of describing components of the present invention and do not limit the use of devices to any particular orientation.

The portable power charger 110 includes a rechargeable battery unit internally disposed within the charger housing supplying 118.4 Wh of portable power. The battery unit can be recharged via a power input, such as a USB-C port provided on the front face of the charger housing. Power output ports are likewise provided for connection to electronic devices. In preferred embodiments, such as illustrated, a USB device charging feature allows the portable power charger 110 to charge electronic devices via four USB-A ports and two USB-C ports. Similarly, each of the battery expansion modules 120 includes two USB-C power output ports. It is noted that the type of port can vary without departing from the principles and spirit of the present invention. A manual “on/off” push button is provided on each component of the portable power station.

The portable power charger 110 also includes a jump start power output adapted to be connected to a car battery via jumper cables inserted into the jump start port.

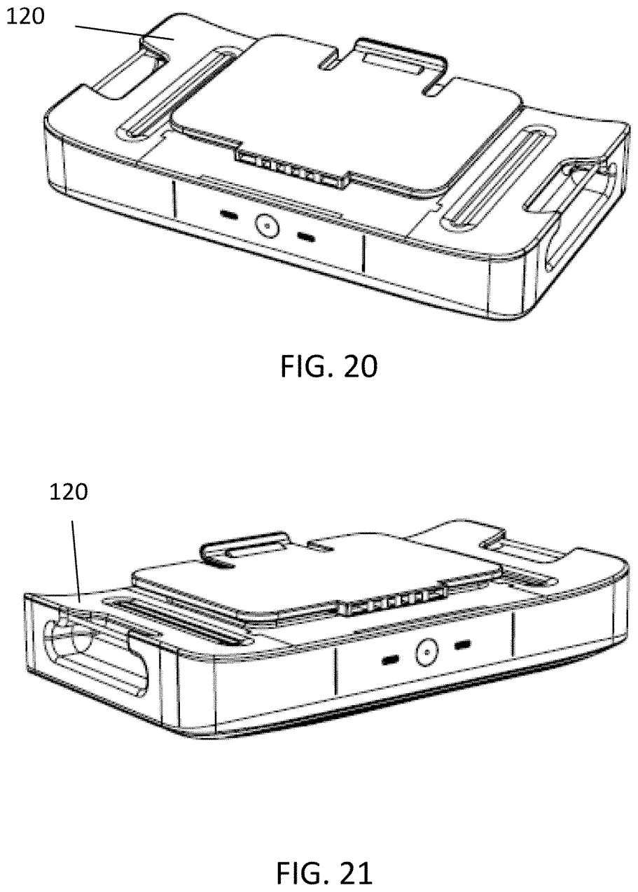

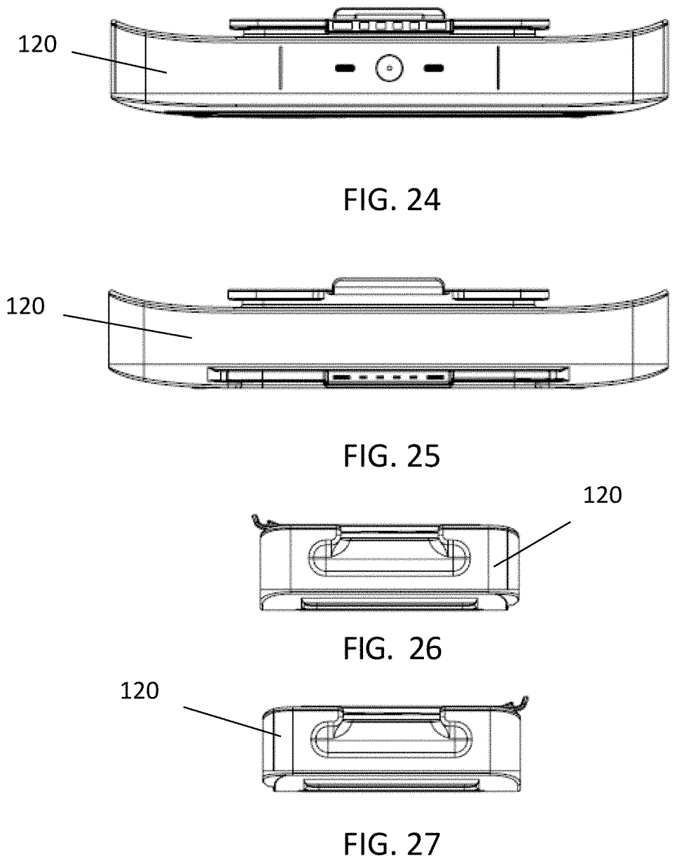

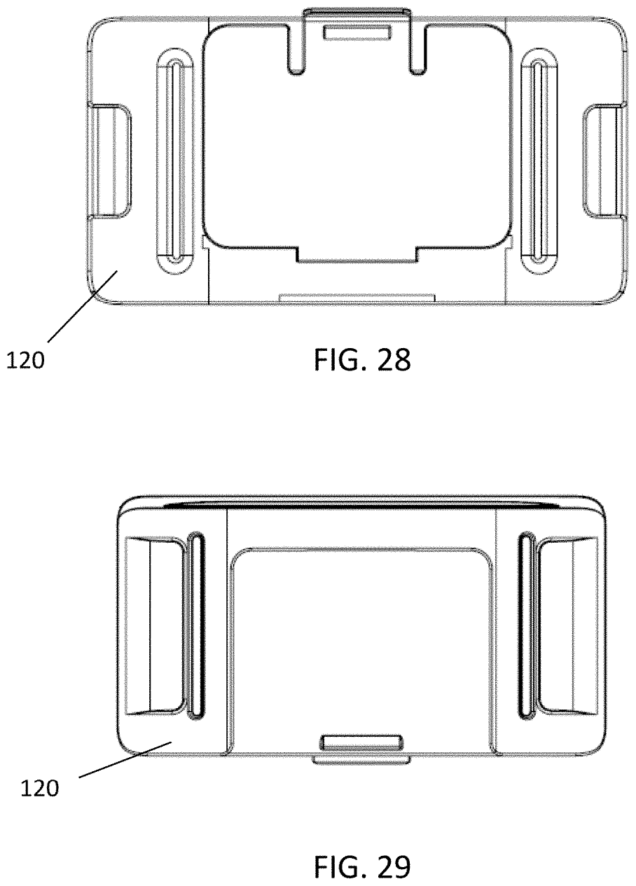

FIGS. 20-29 illustrate a battery expansion module 120 that can be mechanically and electrically connected to the portable power charger 110 in accordance with the present invention. The mechanical connection is by complementary connection means provided on the portable power charger 110 and the battery module 120 for click-and-go engagement. In preferred embodiments, up to 6 expansion modules 120 can be connected to the portable power charger 110 at the same time, increasing the power capacity to up to 1290 Wh. One or more battery expansion modules 120 can be connected to the portable power charger 110 to increase the run time capacity of the portable power station. Each of the battery expansion modules 120 may be provided with further functionalities, such as AC outlets, DC ports, USB ports, other connection ports, lighting, and the like.

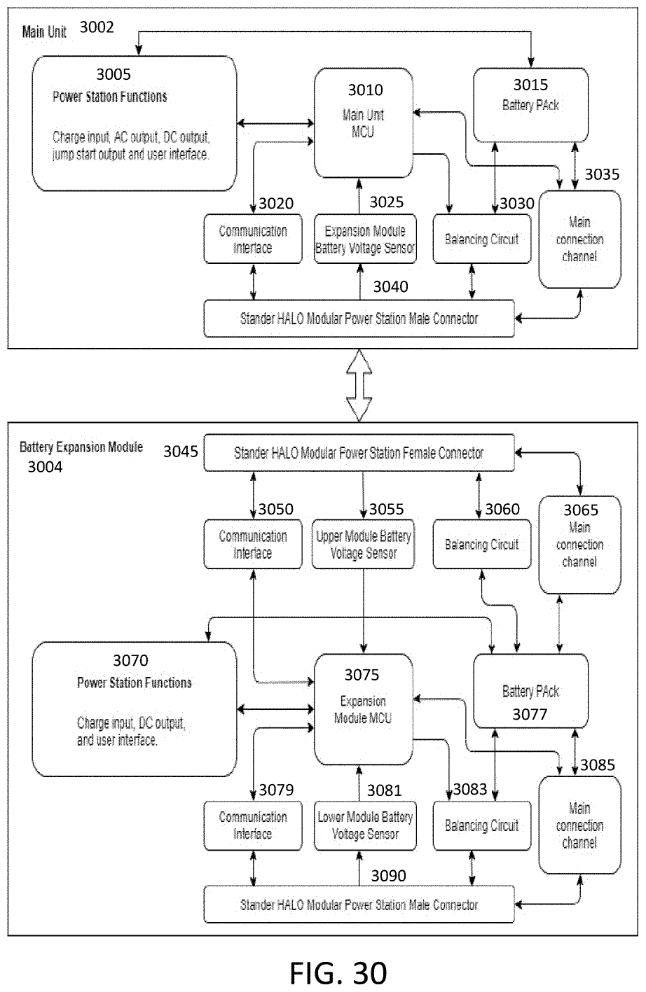

The exploded view provided in FIG. 3 illustrates the complementary mechanical engagement between the male connector on the top of the battery expansion module 120 with the female connector on the bottom of the portable power charger 110. Connection between the portable power charger 110 and a battery expansion module 120 is schematically illustrated in FIG. 30. The same connections, both mechanical and electrical, are used to connection additional battery expansion modules 120 to increase the capacity of the portable power station.

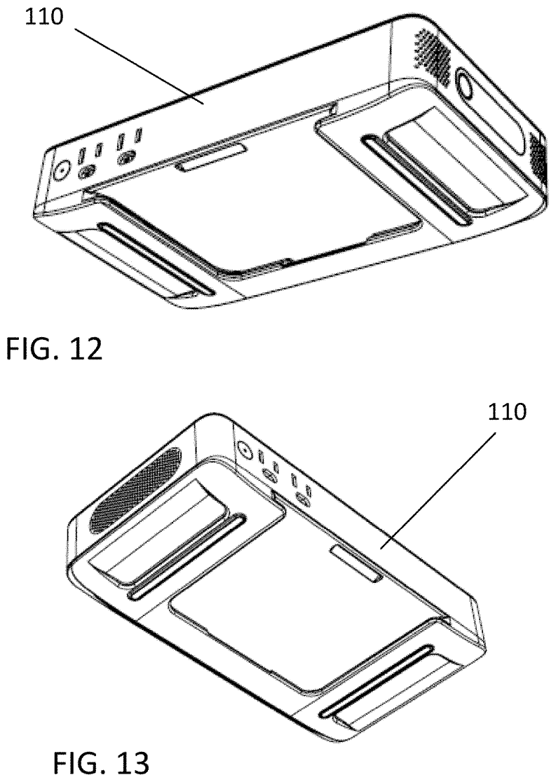

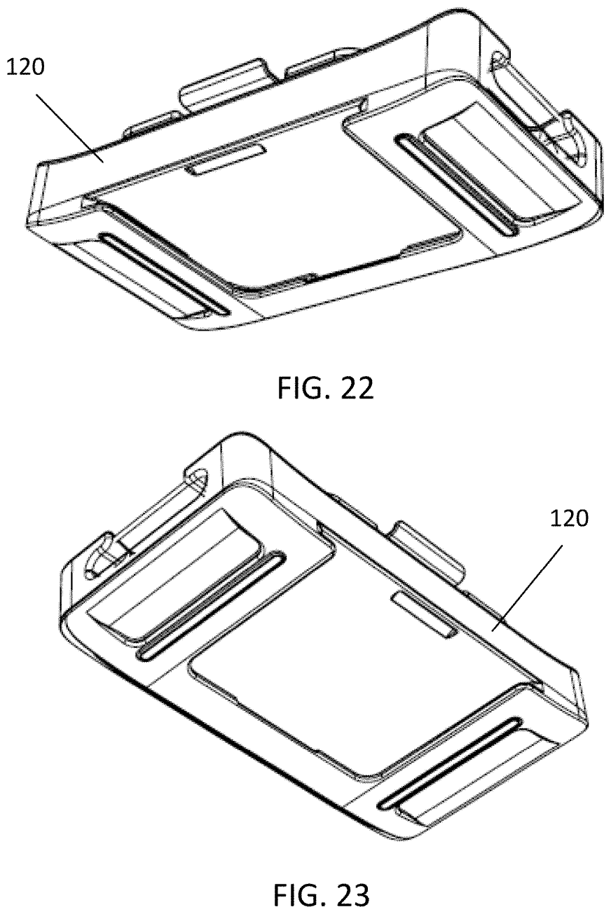

In preferred embodiments, the portable power charger 110 is provided with a female expansion connector, illustrated, for example, in FIGS. 12-13 as a recessed cavity adapted to receive a complementary male expansion connector provided on the battery expansion module 120. In preferred embodiments, each battery expansion module 120 includes both a male expansion connector, for example, situated on the top surface of the module 120, as illustrated in FIGS. 20-21, and a female expansion connector, for example, situated as a cavity in the bottom surface of the module 120, as illustrated in FIGS. 22-23. In this regard, a battery expansion module 120 can be connected to the bottom of the portable power charger 110, and an additional battery expansion module 120 can be connected to the bottom of the first module 120, and so on, in a stacked manner, such as illustrated in FIGS. 1-2 (one expansion module 120) and FIGS. 8-9 (two expansion modules 120). For aesthetic purposes, a bottom cap (not shown) can be provided to cover the female expansion connector on the bottom-most battery expansion module 120, or directly on the portable power charger 110 if it is used alone with no battery expansion modules 120 attached. This cap can protect the connector from damage and exposure.

In the illustrated embodiments, the connectors include a 9-pin slide-in connector to ensure electrical connection between the respective battery units of the portable power charger 110 and any battery expansion modules 120 connected thereto. When a connector is not connected to a complementary connector (male or female), all channels are off. Once a connection is made, the port will automatically detect engagement and the battery pack voltage of the added module (male to female).

To connect a battery expansion module 120 to the portable power charger 110 or another battery expansion module 120, the male connector of the new battery expansion module 120 is mechanically slid into the open female connector on the bottom of the portable power station. The engagement of the connector will snap fit together. To undo the connection, the male connector is elastically biased so that it can be flexed to disengage from the female connector.

During normal power station use, the internal batteries will be discharged when one or more devices are connected to the power station output ports (i.e., AC outputs, DC outputs, USB outputs, etc.). The rate of discharge will vary based on the type and quantity of devices connected. In use, the portable power charger 110 and each of the expansion battery modules 120 can be directly recharged from an external power source, for example, via USB-C input ports provided on the front face of the charger housing or each expansion module. In accordance with preferred embodiments, the modular power station, containing an internal battery capacity of a certain size (Wh capacity), can be charged in a number of different ways (e.g., AC Wall Adapter, Car Charger, USB-C input port). In alternate designs, the power station can be recharged by solar power via solar panels incorporated into the charger housing design. For example, for use in a complete off-grid application, the modular power station can be charged via the use of one or more solar panels. Such solar panels can vary in size and output which will vary the charge speed of the power station.

The modular power station also provides the ability to be charged and discharged simultaneously. The simultaneous charging of the power station during use will allow a longer run-time for connected devices. When an external power source is readily available, the power station can be plugged in for recharge while also distributing charge to electronic devices needing recharge. For off-grid scenarios specifically, the added use of solar panels will allow the power station to be charged when the solar panels are connected and placed in direct sunlight. However, the charging speed from the solar panels will be highly dependent on the weather, solar angle and solar radiation. This limits how quickly the internal battery capacity of the power station can be recharged (for continuous use). A hybrid solar/propane system can be considered to boost charge speed and run-time for the power station. Propane fuel can be used to produce charge electricity (by converting the energy produced from the combustion of propane) which is used to recharge the internal battery capacity of the power station. Considering this scenario, the solar panels can be used to recharge the power station during the day (when optimal sunlight is available) and the power station can automatically initiate recharging from propane fuel when adequate sunlight is not available (i.e., based on weather or during use at night). In such alternate embodiments, the power station can be sized to utilize one or more solar panels or one or more propane tanks that can be used for extended power outages. Device run-time would be highly dependent on the rate of the power station discharge along with the rate of charge.

The battery expansion modules 120 also each include a rechargeable internal battery unit. Additionally, each module 120 includes an LED battery level indicator that will identify the capacity of the battery unit. If a recharge is needed, the expansion module 120 can be connected to an external power source via a power input port.

The DC to AC inverter feature of the portable power station is provided in the portable power charger 110. This inverter feature allows the station to be used for any electronic device that operates at 110V+/−10VAC, 60 Hz and operates at a rated power of 1000 Watts or less. This can include a refrigerator that uses a U.S. standard AC plug. In the alternate, a battery expansion module can include a DC to AC inverter module, such as the middle unit illustrated in the embodiment of FIG. 32.

Many of the operative control functions are located on a front face of the portable power charger 110, as generally illustrated in FIG. 4. For example, jump start controls may be used when jump starting a 12V car battery. As illustrated, the jump start controls include cable port 150, shown covered by a protective door, and a jump start button. The cable port 150 may include differently-shaped positive and negative 12 V jumper cables (not shown). In embodiments, jumper cables may include an EC5 connector.

Charging controls include at least one 5V USB output port for charging 5V portable electronic devices. The charging controls also may include an ON/OFF button.

In preferred embodiments of the present invention, a user display is provided. The display may be an LCD screen 130 as shown in FIG. 4. Operational data is generally displayed on the display 130 to facilitate use of portable power station by a user. Any operational alerts associated with the functioning of the portable power charger 110—for example, failure of an operational safety check, low battery, and low or high temperature—will be indicated on the display 130.

In embodiments of the portable power charger 110, the display 130 may include a power indicator that will indicate the remaining capacity of the internal rechargeable battery unit in the power charger. For example, the illustrated digital power indicator means comprises a series of five LED lights, but may include more or fewer lights without departing from the principles and spirit of the present invention. When the battery is at “full” capacity—i.e., electric quantity between about 76% and about 100%—all the lights will be illuminated. As the battery power decreases, the lights will correspondingly decrease by one as the power is used. Additionally, the lights will change color as the capacity level decreases—for example, when fully charged, all lights will be green; when the battery is half full the lights that are lit-up will be yellow or a combination of yellow and red; when the battery is low, the lights that are lit-up will be red. Alternatively, display may include a digital readout that provides a battery capacity level for the internal rechargeable battery unit of the portable power charger, or another known means of providing battery level information such as “Battery Too Low” message.

The display 130 can also provide an indication of any battery expansion modules 120 attached to the portable power charger 110, and how the battery capacity, available power output and projected runtime has been affected.

Other data provided on the display 130 may include a temperature warning indicator, a safety check fail indicator, and a vehicle battery OK indicator. These indicators may be used during jump starting a vehicle, or other operating conditions of portable power station.

Although a specific arrangement of controls on front face of the charger housing is depicted, this arrangement is merely for illustration purposes and embodiments of the present invention are not limited to those shown and described herein. For example, jump start controls, charging controls and control and display controls may be arranged in a different order. Similarly, the charging controls may include additional USB ports. Additionally, though shown and described as USB ports, the ports may use other known connection interfaces, such as micro-USB, mini-USB, Apple Lightning™, Apple 30-pin, for example.

The portable power charger 110 could be modified to include an air compressor, such as described and shown in co-pending U.S. application Ser. No. 17/060,722, filed Oct. 1, 2020, incorporated herein by reference. In this regard, the charger housing could include a recessed area defining a storage cavity for retaining an air compressor hose with end fitting for use with such an air compressor located inside the charger housing. The hose would be retractable for storage in the storage cavity when the air compressor is not being used.

In alternative designs, a DC input port can provide connection means for recharging the internal battery unit of the portable power charger 110 via connection to external power sources using appropriate charging cables with AC/DC charging adaptors, as needed. In embodiments, the DC input port is a barrel-type power connector with an operating voltage of approximately 14VDC, an input current of approximately 850 mA and an input power of approximately 14 watts. The display 130 may show information indicating that charger 110 is being charged and the charge percentage.

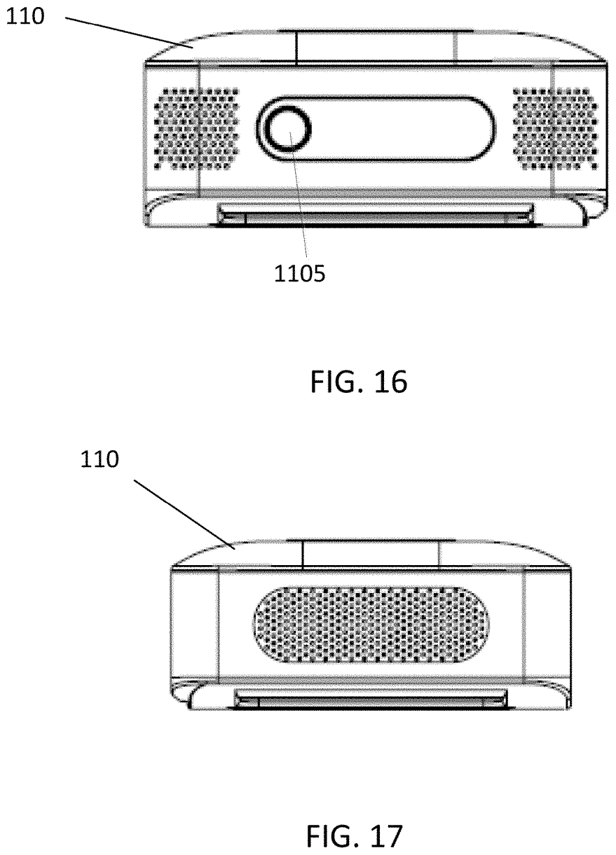

FIGS. 11 and 16 illustrate a floodlight 1105 with an ON/OFF switch for use in emergency situations.

In alternate embodiments of the portable power station, connector cables (not shown) operatively may be storable within cavities formed in the charger housing from which they may be removed to connect to electronic devices in need of a recharge. Still further, such charging cables can be removable and replaceable so that varying connector interfaces—e.g., USB, Micro-USB, mini-USB, Apple Lightning™, or Apple 30-pin—may be used with the portable power charger 110.

In embodiments, control circuitry may keep track of the capacity level of the battery unit, store data or provide a conduit means by which data can be exchanged between electronic devices, such as between a smart phone and a computer. The control circuitry may also communicate with the battery unit to determine how much capacity is remaining in the battery. Upon determining the capacity level, the processing unit may communicate with the power indicator means to provide the user with information for how much capacity is remaining in the internal rechargeable battery unit and whether the charger 110 needs to be connected to an external power source for recharging. For example, if the internal battery unit needs to be charged, a “Battery Too Low” indicator will be provided on the LCD display 130 along with the low battery visual indicator and the specific charge percentage remaining in the battery. Similarly, if the portable power charger 110 is connected to an external power source for recharging the internal battery unit, the display 130 will provide an indication that the battery is charging along with the specific charge percentage for the battery.

FIG. 30 shows a functional block diagram of the portable power charger 110. The Main Unit 3002 communicates to the Battery Expansion Unit 3004 via a universal connection interface. The Power Station Functions 3005 provide the basic input/output functions and user interface of the power station. The functions contained in the Power Station Functions are Charge Input, AC output, DC Output, the Jump Start Output and User Interface.

The Charge Input uses the USB-C input ports 140 of FIG. 4. They are used to charge the internal battery. There is a battery level indicator which identifies the charge capacity of the main unit internal battery. The AC output uses a DC to AC converter to produce a pure sinusoid AC output that can be used to power an electronic device that will take a 110VAC+/−10 VAC at 60 Hz. This may be used to power a refrigerator that uses a standard AC plug. The AC output is enabled by pressing the AC push button 111 shown in FIG. 2. The DC output includes a wireless output, USB output and the jump start output. The USB outputs are the ports 140 shown in FIG. 4 which are USB -A and USB-C ports. The wireless output will allow the Main Unit to charge electronic devices wirelessly shown as the Mophie interface on the top of the unit as shown in FIG. 1. The jump start output will allow the unit to jump start a vehicle providing up to 2000 Amps of cranking current at temperatures as low as −10° C.

The User Interface, preferably associated with the LCD display 130 on the portable power charger 3002, will display battery fuel gauge, charge input power, AC output power, DC output power, wireless function active state, external voltage on jump start port, and abnormal state alarms.

The Communication Interface 3020 will provide a communication path between the main charger unit 3002 and any connected battery expansion module 120. The Communication Interface 3020 will allow the MCU 3010 in the main unit 3002 to communicate with the MCU 3075 in the battery expansion module 3004. The information such as charge/discharge state, charge input power, discharge output power, battery pack voltage, and number of connected modules will be exchanged via the Communication Interface 3020. The Balancing Circuit 3030 will allow the battery pack within the main unit 3002 and battery pack within the battery expansion modules 3004 to maintain a balanced energy/charge level. The Balancing Circuit 3030 depends on the Expansion Module Battery Voltage Sensor 3025 to monitor and transmit the connection state and voltage of any connected battery expansion module to the MCU. The Balancing Circuit 3030 has an input channel and an output channel. The input and output channels are used to determine the state of charge (SoC) on any connected battery expansion module. The input and output channels will also provide some charge control in collaboration with the MCU 3075 for the connected battery expansion modules. When the main unit battery pack 3015 voltage is higher than the battery expansion module's battery 3077 voltage and the voltage difference is higher than 0.5V, the Balancing Circuit will enable its output channel so that the main unit 3002 will charge the battery expansion module 3004 to make the voltage difference less than 0.5V. On the contrary, when the main unit battery pack voltage is lower than the battery expansion module's battery voltage and the voltage difference is higher than 0.5V, the Balancing Circuit 3030 will enable its input channel so that the battery expansion module will charge the main unit to make the voltage difference less than 0.5V. The Balancing Circuit 3030 will be disabled once the voltage difference is less than 0.5V.

The Main Connection Channel 3035 electrically connects the battery packs with the main unit 3002 and the battery expansion module 3004. Once connected, the main unit 3002 and expansion modules 3004 can work together to provide output power for the power station functions. When the voltage difference between the two connected modules is less than 0.5V, the main connection channel will open and connect the two modules' battery pack together. The Battery Expansion Module 3004 functional block diagram depicts the key functional components and communication flow for the design. Like the main unit, it contains a Battery Pack 3077 and an MCU 3075 which controls the Power Station Functions 3070, the Communication Interfaces 3050 and 3079, two Balancing Circuits 3060 and 3083, and the Main Connection Channels 3065 and 3085.

The battery expansion module(s) 3004 provides added run-time capacity along with an additional charge interface for faster charging. The battery expansion module 3004 will also provide a DC output and UI. The battery expansion module 3004 will communicate with the main unit 3002 via a universal connection interface via the Modular Power Station male connector 3040 and the Modular Power Station female connector 3045.

The Power Station Functions 3070 will provide the basic input/output functions and UI (user interface) of the battery expansion module 3004. The functions include the charge input, DC output and the LED user interface. For charge input, the battery expansion module 3004 may be recharged via USB-C input ports. The LED indicator will identify the charge capacity of the battery expansion module's internal battery. DC Outputs include 2× USB-C outputs. LED Indicators include the LED indicators and will display battery fuel gauge along with balancing state.

The Communication Interfaces 3020, 3050 and 3079 will provide a communication path between the battery expansion module 3004 and the main unit 3002 along with any other connected battery expansion module 3079. The Communication Interfaces 3020, 3050 and 3079 will allow the MCU 3010 in the main unit 3002 to communicate with the MCU 3075 in the battery expansion module 3004. The information such as charge/discharge state, charge input power, discharge output power, battery pack voltage, and number of connected modules will be exchanged via Communication Interface 3020, 3050 and 3079.

The Balancing Circuits 3030, 3060 and 3083 will allow the battery pack 3077 within the battery expansion module 3004 and battery pack 3015 with the main unit 3002 or any other connected battery expansion module 3004 to maintain a balanced energy/charge level. The Balancing Circuits 3060 and 3083 in the battery expansion module 3004 depend on the upper 3055 and lower 3081 battery voltage sensors to monitor and transmit the connection state and voltage of any connected battery expansion module 3004 to the MCU 3075. The Balancing Circuits 3030, 3060 and 3083 have an input channel and an output channel. The input and output channels are used to determine the state of charge (SoC) on any connected main unit 3002 or battery expansion modules 3004. The input and output channels will also provide some charge control in collaboration with the MCU 3075 for the connected battery expansion modules 3004. When the internal battery pack 3077 voltage is higher than the external battery pack voltage and the voltage difference is higher than 0.5V, a Balancing Circuit will enable its output channel so that the internal battery pack will charge the external battery pack to make the voltage difference less than 0.5V. On the contrary, when the internal battery pack voltage is lower than the external battery pack voltage and the voltage difference is higher than 0.5V, the Balancing Circuit will enable its input channel so that the external battery pack will charge the internal battery pack to make the voltage difference less than 0.5V. The Balancing Circuit will be disabled once the voltage difference is less than 0.5V.

The battery expansion module 3004 connects to another battery expansion module 3004 through the Modular Power Station Male connector 3090.

The Main Connection Channel 3085 electrically connects the battery packs with the battery expansion module 3004, the main unit 3002 and other battery expansion modules 3004. Once connected, the main unit 3002 and expansion modules 3004 can work together to provide output power for the power station functions. When the voltage difference between the two connected module is less than 0.5V, the main connection channel will open and connect the two modules' battery packs together.

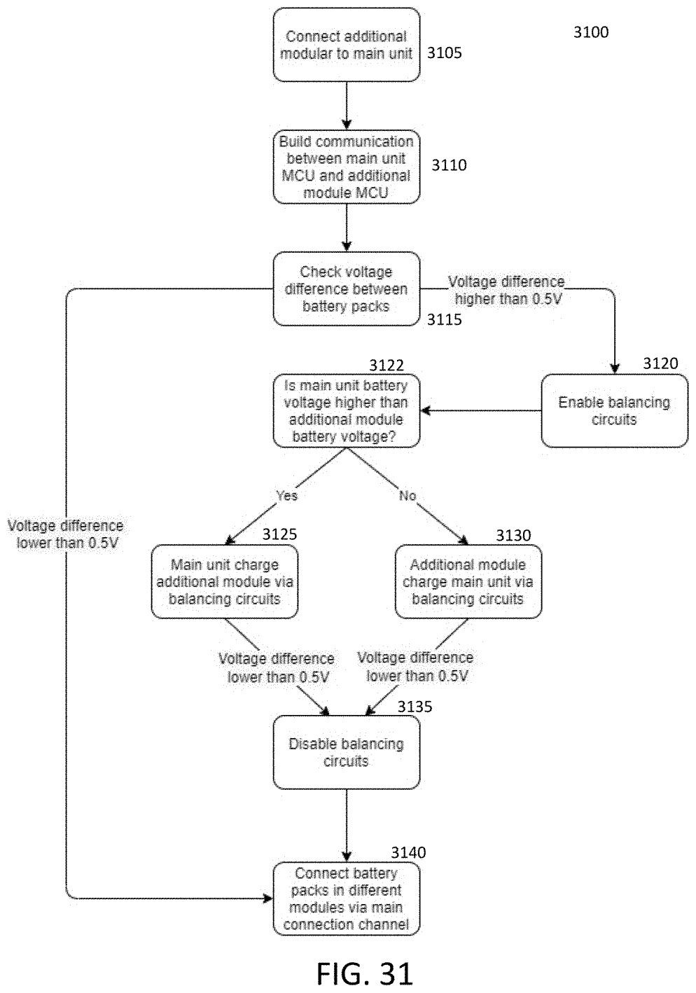

FIG. 31 shows a flowchart of balancing between the battery units of connected components of a modular portable power station. The flow begins when an additional module is connected to the main unit 3105. It then builds communication between the main unit MCU and an additional module MCU 3110. The system checks the voltage difference between the battery packs 3115. If the difference in voltage is greater than 0.5V, the balancing circuits are enabled 3120.

If the main unit battery voltage is higher than the additional module battery voltage 3122, the main unit charges the additional module via balancing circuit 3125. Alternately, if the additional module battery has a higher voltage, the additional module charges the main unit via the balancing circuit 3130. When the difference in voltage falls below the 0.5V threshold, the balancing circuits are disabled 3135. The battery packs are then connected via the main connection channel 3140. When the battery packs are within 0.5 V, the battery packs are connected.

Inside the power charger housing, the portable power charger houses a charger battery (e.g., a lithium ion type battery), for providing charging power to electronic devices via USB ports or jumper cable jacks. The charger further includes a safety circuit that operatively connects the power supply with the jumper cable jacks via an outlet and generally enables operative connection of the jumper cable jacks or interrupts at least the operative connections of the charger jacks with the internal battery unit in case any of the following shut off conditions occurs: insufficient voltage across the positive and negative charger jacks; reverse polarity of the positive and negative charger jacks; reverse current to the charger battery; or excess temperature of the charger battery. Operation of the safety circuit for the portable power station is in accordance with U.S. Pat. Nos. 10,075,000, 10,250,056 and 10,840,716, incorporated herein by reference.

The portable power station in accordance with the present invention includes the following safety protection:

Overload Protection—automatically detects if a connected device is within the tolerable surge and rated power range of the inverter (1-1000 Watts); an overload condition can be indicated with a flashing red LED warning when output power is greater than 1500 Watts+/−10 Watts for 5 seconds or when peak power is detected over 2000 Watts for 500 ms.
Battery Input Voltage—automatically detects if the input voltage from the battery expansion modules is less than 12.0VDC.
Output Voltage and Current Protection—automatically detects if AC voltage (110+/p31 10 VAC) amplitude (MSW) and current are outside of the inverter specification.
Reverse Polarity Protection—ensures that jumper cables are always properly connected to vehicle battery terminals; a jump start button will rapid flash if cables are not connected properly and the safety circuit in the portable power station will not allow a jump start sequence to proceed.
Reverse Current Protection—detects if a vehicle battery is attempting to back feed the portable power station. The power station will shut off if this condition is detected—for example, if the safety circuit detects 10 Amps or greater in the reverse direction.
Over Voltage Protection—detects if vehicle battery voltage is greater than 12.8V+/−0.3V. If this condition is met, a jump starts attempt will not be permitted.
Low Voltage Protection—detects if vehicle battery voltage is less than 1V+/−0.5V. If this condition is met, a jump starts attempt will not be permitted.
Short Circuit Protection—will not allow inadvertent connection of the positive and negative jump start cables prior to a jumpstart attempt.
Jumper Cable Spark Protection—the portable power station will only allow a cold jump start connection; this eliminates the potential of sparking while connecting and disconnecting jumper cables.
Timer Circuit Protection—detects that valid jump start conditions are met.

The present invention includes some unique charging features for operation of the portable power station. The portable power charger will charge independently through each USB-C input (100 Watts Max) via each port. The total charge input for the main unit is 200 Watts. The battery expansion modules will also charge independently through each USB C input at 100 Watts each and 200 Watts total for the expansion unit. The charging becomes unique once one or more expansion module is connected to the main portable power charger. Once connected, the portable power charger along with each of the modules will negotiate between each other and balance the charge level, such as illustrated in FIG. 31. For example, when the portable power charger is connection to a battery expansion module, if the voltage difference between the respective battery units is higher than 0.5V, then the main connection channel with turn off so that the balancing charge and the discharge charge can automatically balance. After the voltages are balanced, the main connection channel will turn on. This essentially means that once connected, the user can charge via one of the USB-C ports on the main portable power charger or any expansion unit and the combined portable power station will take this charge input and automatically balance the charge level between all the units connected. Similarly, if the user connects a charge input to each of the USB-C inputs, it will take this charge input and balance the charge level between the main portable power charger and all connected expansion modules. The benefit and differentiation in this case is that the user can scale the charging performance. For example, if the main power charger is connected with five expansion modules, and then the power station is connected with a charge input to each USB-C port, the entire system can be charged at 1200 Watts (6×200 Watts each) and the units will automatically balance in the internal packs for each module in the background. This port segregation input and battery pack auto balancing is unique to the present invention.

Similarly, regarding the discharge mechanism for the present invention and specifically the AC output ports, the power outputs will auto-balance and discharge the packs across all the expansion modules. The high surge current requirements are provided by the high discharge pack located on the main portable power charger when necessary to provide high power output. This is unique in that high-power output is always available from the main portable power charger whether or not any expansion modules are connected.

As noted, the portable power station can be modified, as needed, by connecting one or more battery expansion modules 120 to the portable power charger 110. Moreover, each of the battery expansion modules 120 can include different functionalities, such as illustrated in FIG. 32, where a portable power charger 110 is connected, mechanically and electrically, to a first battery expansion module 120a that can act as a DC to AC inverter module, and which is provided with multiple AC outlets. A second battery expansion module 120b is connected, mechanically and electrically, to the first battery expansion module 120a, and includes multiple USB connection ports. Various combinations and designs are possible without departing from the principles and spirit of the present invention.

The foregoing description of embodiments of the invention has been presented of the purpose of illustration and description. It is not intended to be exhaustive or to limit the invention to the form disclosed. Although exemplary embodiments of the invention have been described with reference to attached drawings, those skilled in the art nevertheless will apprehend variations in form or detail that are consistent with the scope of the invention as defined by the appended claims.

What is claimed is:

1. A modular portable power station comprising:
a portable power charger comprising:
a first housing including first connection means;
a first battery disposed within the first housing;
a plurality of ports disposed in the housing, said plurality of ports further a port for a jump start cable and at least one charging port; and
a controller for controlling the operation of the portable safety device; and
a battery expansion module comprising:
a second housing including second connection means adapted to complement and engage the first connection means to connect the battery expansion module to the portable power charger; and
a second battery disposed within the second housing;
wherein the first battery is in electrical communication with the second battery when the portable power charger is connected to the battery expansion module via engagement between the first connection means and the second connection means.

2. The modular portable power station according to claim 1, wherein the battery expansion module includes third connection means that match the first connection means of the portable power charger such that said third connection means complement and can engage second connection means on a second battery expansion module in order to connect two such battery expansion modules together.
